(19) United States
(12) Patent Application Publication
(10) Pub. No.: US 2025/0166039 A1
(43) Pub. Date: May 22, 2025

(54) Information Providing System, Oscillator Providing System, And Processing Method

(71) Applicant: SEIKO EPSON CORPORATION, Tokyo (JP)

(72) Inventors: Yuichi TORIUMI, Minowa (JP); Nobutaka SHIOZAKI, Shiojiri (JP); Yasuhiro SUDO, Chino (JP)

(21) Appl. No.: 18/949,025

(22) Filed: Nov. 15, 2024

(30) Foreign Application Priority Data
Nov. 16, 2023 (JP) 2023-194924

(51) Int. Cl. G06Q 30/0601; G06Q 50/04

(52) U.S. Cl. CPC G06Q 30/0629; G06Q 30/0627; G06Q 50/04

(57) ABSTRACT

An information providing system includes a reception unit, a processing unit, and a transmission unit. The reception unit receives desired characteristic data of a programmable oscillator input in a user terminal. The processing unit extracts compatible product information that is product information of the programmable oscillator compatible with the desired characteristic data and substitute product information that is product information of an oscillator to be a substitute proposal target. The transmission unit transmits the compatible product information and the substitute product information to the user terminal.

The present application is based on, and claims priority from JP Application Serial Number 2023-194924, filed Nov. 16, 2023, the disclosure of which is hereby incorporated by reference herein in its entirety.

### BACKGROUND

### 1. Technical Field The present disclosure relates to an information

providing system, an oscillator providing system, a processing method, and the like.

### 2. Related Art

There has been known a method of systemizing order reception to delivery of an oscillator or the like. JP-A-2002-117285 discloses a method of preparing blank oscillators in advance for each of offices of a manufacturer and a server of the manufacturer selecting an office suitable for transfer of an oscillator based on order data received from a terminal of a customer and transmitting data to be written in the blank oscillator to the selected office to realize early delivery of the oscillator.

JP-A-2002-117285 is an example of the related art.

The technique disclosed in JP-A-2002-117285 merely provides the oscillator including the same data as the order data of the customer. The provision of the oscillator is not always an optimum solution to a problem of the customer. For that reason, it is desired to construct a system that gives an opportunity for a customer to consider an optimum oscillator at a stage when the customer orders an oscillator.

### SUMMARY

An aspect of the present disclosure relates to an information providing system including: a reception unit configured to receive desired characteristic data of a programmable oscillator input in a user terminal; a processing unit configured to extract compatible product information that is product information of the programmable oscillator compatible with the desired characteristic data and substitute product information that is product information of an oscillator to be a substitute proposal target; and a transmission unit configured to transmit the compatible product information and the substitute product information to the user terminal.

Another aspect of the present disclosure relates to an oscillator providing system including the information providing system explained above and the user terminal.

Another aspect of the present disclosure relates to a processing method including: processing of receiving desired characteristic data of a programmable oscillator input in a user terminal; processing of extracting compatible product information that is product information of the programmable oscillator compatible with the desired characteristic data and substitute product information that is product information of an oscillator to be a substitute proposal target; and processing of transmitting the compatible product information and the substitute product information to the user terminal.

### BRIEF DESCRIPTION OF THE DRAWINGS

FIG. 1 is a diagram illustrating a configuration example of an information providing system and an oscillator providing system.

FIG. 2 is a flowchart illustrating a processing example in an embodiment.

FIG. 3 is a diagram illustrating another configuration example of the oscillator providing system.

FIG. 4 is a flowchart illustrating a processing example of product information extraction processing.

FIG. 5 is a flowchart illustrating a processing example of first substitute product information extraction processing.

FIG. 6 is a flowchart illustrating a processing example of second substitute product information extraction processing.

FIG. 7 is a diagram illustrating a screen example to which a method in the embodiment is applied.

FIG. 8 is a diagram illustrating a screen example relating to first substitute product information.

FIG. 9 is a diagram illustrating a screen example relating to second substitute product information.

FIG. 10 is a diagram illustrating a screen example of urging trial production based on substitute product information.

### DESCRIPTION OF EMBODIMENTS

A preferred embodiment of the present disclosure is explained in detail below. The embodiment explained below does not unduly limit the content described in the claims. Not all of components explained in the embodiment are essential elements.

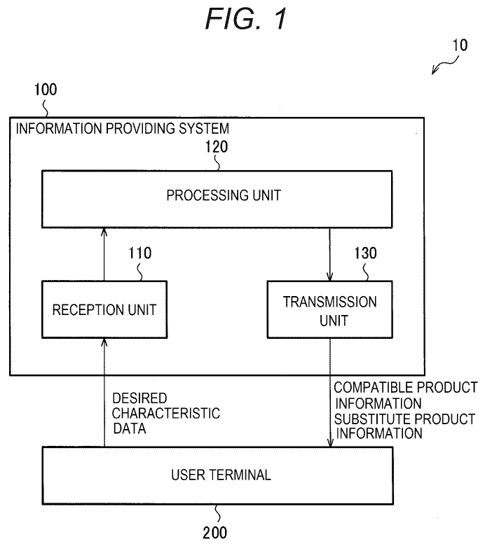

FIG. 1 is a diagram illustrating a configuration example of an oscillator providing system 10 in the present embodiment. In FIG. 1, the oscillator providing system 10 includes an information providing system 100 and a user terminal 200. The information providing system 100 is connected to the user terminal 200 via a network. The network is specifically a public communication network such as the Internet but may partially include an intranet. The information providing system 100 illustrated in FIG. 1 is illustrated as including one user terminal 200 but may include a plurality of user terminals 200.

As illustrated in FIG. 1, the information providing system 100 includes a reception unit 110, a processing unit 120, and a transmission unit 130. The information providing system 100 is a system managed by a manufacturer of an oscillator explained below and is implemented by a server or the like functioning as the reception unit 110, the processing unit 120, and the transmission unit 130 explained below. In the following explanation, “a manufacturer of an oscillator” is simply described as “manufacturer”. Here, the server is a server used by the manufacturer and may be, for example, a physical server owned by the manufacturer or may be a cloud server that is present outside a base of the manufacturer and is managed by the manufacturer.

A target provided by the oscillator providing system 10 in the present embodiment is an oscillator that outputs a clock signal. Although a basic configuration of the oscillator is not illustrated because the basic configuration is publicly known, the oscillator is housed in a package in a state in which a resonator has high airtightness. Specifically, the resonator can be implemented by, for example, a surface acoustic wave (SAW) resonator, an AT cut quartz crystal vibration element, an SC cut quartz crystal vibration element, a tuning fork type quartz crystal vibration element, another piezoelectric vibration element, a micro-electro-mechanical system (MEMS) vibration element, or the like. One end of the resonator is coupled to a not-illustrated first electrode and the other end is coupled to a not-illustrated second electrode.

The oscillator includes, besides an oscillation circuit, a not-illustrated first resonator coupling terminal and a not-illustrated second resonator coupling terminal. The first resonator coupling terminal is coupled to the first electrode explained above and the second resonator coupling terminal is coupled to the second electrode explained above. Accordingly, the oscillation circuit vibrates the resonator and functions as a generation circuit for a reference clock signal that is an oscillation signal. The oscillator functioning as explained above is, for example, a simple packaged quartz crystal oscillator (SPXO) but may be a voltage-controlled quartz crystal oscillator (VCXO), a temperature-compensated quartz crystal oscillator (TCXO), an oven equipped quartz crystal oscillator (OCXO), a surface acoustic wave (SAW) oscillator, a voltage-controlled SAW oscillator, a micro-electro-mechanical system (MEMS) oscillator, or the like.

Oscillators can be roughly divided into a programmable oscillator 300 in which a frequency can be variable set and a fixed frequency oscillator in which a frequency of an output clock signal output from a not-illustrated output circuit depends on the shape of a resonator and a frequency is fixed. That is, categories of products relating the to oscillators include the programmable oscillator 300 and the fixed frequency oscillator. Although the frequency of the output clock signal cannot be optionally changed in the fixed frequency oscillator, the programmable oscillator 300 can output an output clock signal having any frequency based on the reference clock signal explained above. In general, the fixed frequency oscillator is less expensive and more excellent in terms of performance compared with the programmable oscillator 300, the manufacturer checks market needs and prepares a product lineup of fixed frequency oscillators having frequencies with high needs from a strategic point of view. In the present embodiment, a nominal frequency in a fixed frequency oscillator sold as a mass-production specification product by the manufacturer is referred to as “standard frequency”. In the following explanation, the nominal frequency is sometimes simply described as frequency as appropriate.

In the programmable oscillator 300, for example, the reference clock signal output from the oscillation circuit explained above is input to a not-illustrated PLL circuit and an output clock signal having a frequency different from the frequency of the reference clock signal is output. Although not illustrated, the PLL circuit includes, for example, a phase comparison circuit, a control voltage generation circuit, a voltage-controlled oscillation circuit, and a frequency division circuit, whereby functions of the PLL circuit are implemented. That is, the phase comparison circuit performs phase comparison between the reference clock signal and a feedback clock signal explained below and outputs a pulse signal having a pulse width proportional to a phase difference to the control voltage generation circuit. The control voltage generation circuit performs a charge pump operation and filter processing based on the input pulse signal, generates a control voltage for controlling oscillation of the voltage-controlled oscillation circuit, and outputs the control voltage to the voltage-controlled oscillation circuit. The voltage-controlled oscillation circuit is a Voltage controlled oscillator (VCO) and includes a variable capacitance element such as a varactor. When the capacitance of the variable capacitance element changes according to the magnitude of the input control voltage, the voltage-controlled oscillation circuit generates, with an oscillation operation, a predetermined clock signal having a frequency corresponding to the control voltage and transmits the predetermined clock signal to the frequency division circuit. The frequency division circuit frequency-divides the received predetermined clock signal based on a set frequency division ratio and outputs the frequency-divided predetermined clock signal to the phase comparison circuit explained above as a feedback clock signal. Thus, a basic operation of the PLL circuit can be implemented. The frequency division ratio is determined by, for example, a frequency division ratio data signal from a not-illustrated processing circuit. The processing circuit includes, for example, a logic circuit but may include a CPU. The frequency division ratio data signal is determined based on a setting value of a register provided in, for example, the not-illustrated processing circuit and including a flip-flop. That is, setting the frequency of the output clock signal of the programmable oscillator 300 to a desired frequency means setting a value of the register to a desired value. Although detailed explanation is omitted, the PLL circuit is not limited to the configuration explained above and may be, for example, a fractional-N type PLL circuit. In this case as well, setting of the register is required.

The programmable oscillator 300 may include a nonvolatile memory. The nonvolatile memory is, for example, a one-time programmable read-only memory (PROM) but may be an electrically erasable programmable read-only memory (EEPROM) or a flash memory. In this way, setting data set in the register can be stored in the nonvolatile memory. Accordingly, when power supply is performed again after being lost, a setting value stored in the nonvolatile memory can be expanded to bits of registers. Accordingly, the programmable oscillator 300 can stably output a clock signal having a desired frequency when the power supply is intermittently performed. To store the setting data in the nonvolatile memory, a characteristic writing device 400 explained below is used. In the following explanation, storing data in the nonvolatile memory is sometimes referred to as, for example, writing data in the nonvolatile memory.

The reception unit 110 is a communication interface that is communicably connected to an external device via a network. The reception unit 110 can be implemented by an independent semiconductor device having a communication function conforming to a predetermined communication standard but may be implemented as a part of functions of a semiconductor device also having other functions. The predetermined communication standard is, for example, a wired communication standard such as Ethernet (registered trademark) or a wireless communication standard such as Wi-Fi (registered trademark) but may be another communication standard. In the following explanation, “communication connection conforming to a communication standard” is described as “communication connection” or simply described as “connection” as appropriate. The reception unit 110 in the present embodiment receives desired characteristic data of the programmable oscillator 300 input to the user terminal 200. Details of the desired characteristic data are explained below.

The processing unit 120 performs processing of the units of the information providing system 100. The processing unit 120 includes the following hardware. The hardware includes a circuit for processing a digital signal but may further include a circuit for processing an analog signal. For example, the hardware can include one or a plurality of circuit devices and one or a plurality of circuit elements mounted on a circuit board. The one or the plurality of circuit devices are, for example, integrated circuits (ICs) and field-programmable gate arrays (FPGAS). The one or the plurality of circuit elements are, for example, resistors or capacitors. The processing unit 120 is implemented by including at least one processor explained below. The processing unit 120 includes a memory that stores not-illustrated information and a processor that operates based on the information stored in the memory. The information is, for example, programs and various data. The processor includes hardware. As the processor, various processors such as a CPU, a GPU (Graphic Processing Unit), and a DSP (Digital Signal processing unit) can be used. The memory may be a semiconductor memory such as a static random access memory (SRAM) or a dynamic random access memory (DRAM), may be a register, may be a magnetic storage device such as a hard disk drive (HDD), or may be an optical storage device such as an optical disk device. For example, the memory stores computer-readable instructions. The processor executes the instructions, whereby a part or all of the functions of the units of the information providing system 100 are implemented as processing. The instructions may be instructions of an instruction set configuring a program or may be instructions for instructing a hardware circuit of the processor to perform operations. The processing unit 120 in the present embodiment extracts compatible product information that is product information of the programmable oscillator 300 compatible with desired characteristic data and substitute product information that is product information of an oscillator to be a substitute proposal target. Details of these pieces of information are explained below.

The transmission unit 130 is the same communication interface as the reception unit 110. That is, like the reception unit 110, the transmission unit 130 can be implemented by a semiconductor device having a communication function conforming to a predetermined communication standard. In FIG. 1, the reception unit 110 and the transmission unit 130 are illustrated as separate functional blocks. However, this does not prevent the reception unit 110 and the transmission unit 130 from being able to be configured by a single semiconductor device.

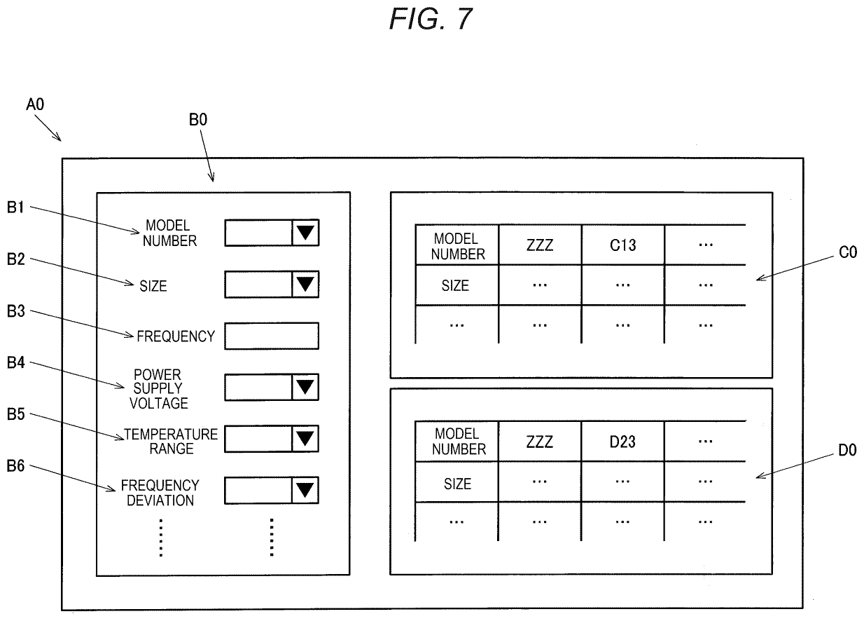

The user terminal 200 is a terminal used by a user and is, for example, a personal computer but may be a mobile terminal such as a smartphone or a tablet. Although not illustrated, the user terminal 200 includes a processor equivalent to the processing unit 120 explained above and has a function of a processing unit. Similarly, although not illustrated, the user terminal 200 includes communication interfaces equivalent to the reception unit 110 and the transmission unit 130 and has a function of a communication unit. Although not illustrated, the user terminal 200 includes a display unit that displays a screen example explained below with reference to FIG. 7 and the like.

A user in the present embodiment is a person who uses an oscillator and can also be considered a customer of a manufacturer. The customer refers to, for example, a person having records of selling or purchasing oscillators from the manufacturer or an organization to which the person belongs and includes a so-called expected customer or an organization to which the expected customer belongs. In the following explanation, “a customer or an organization to which the customer belongs” is simply described as “customer”. The customer is assumed to be mainly a corporation but may be an individual if the individual is likely to purchase a predetermined number of oscillators. The purchase record of oscillators includes a record of receiving provision of services relating to technical support and the like for the oscillators besides a record of receiving provision of sales of the oscillators. The expected customer refers to, for example, a person who is interested in an oscillator sold by the manufacturer and is likely to purchase the oscillator in the near future. For example, in order to integrate an oscillator into equipment under development by the expected customer and evaluate the oscillator, the expected customer inquires the manufacturer about the oscillator with predetermined means and asks the manufacturer to provide a predetermined number of oscillators serving as evaluation samples. The predetermined means is a telephone, a facsimile, an e-mail, or the like but may be an inquiry via a Web page. The predetermined number is determined as appropriate according to evaluation content. Then, the expected customer determines mass-production specifications of the oscillator based on a result of the evaluation and formally orders the oscillator having the determined mass-production specifications from the manufacturer. The ordered oscillator having the mass-production specifications is delivered to the expected customer via a sales agency explained below. Accordingly, a purchase record is generated. Thereafter, the customer is capable of ordering the oscillator having the mass-production specifications via the sales agency. The sales agency refers to an institution that is entrusted with sales of commodities and performs a job of selling the commodities and is, for example, a semiconductor trading company. The sales agency may be a subsidiary of the manufacturer or may have no capital relation with the manufacturer. The sales agency may be a special agent having a special contract with the manufacturer.

In considering use of the oscillator, the customer checks whether a fixed frequency oscillator that oscillates a desired frequency is sold as an existing product. This is because, as explained above, the fixed frequency oscillator is more excellent than the programmable oscillator 300 in terms of cost and quality. However, the frequency desired by the customer does not always coincide with the standard frequency. In such a case, it is also conceivable that, for example, the customer requests the manufacturer to add, to an existing product lineup, a fixed frequency oscillator that outputs an output clock signal having a new frequency. However, unless there is a predetermined reason, the manufacturer is highly likely to not accept the request. The predetermined reason is that, for example, the request is a request from a predetermined customer or a large amount of shipment can be expected. This is because, since considerable development man-hours are required from when a dedicated resonator is designed anew until the resonator is commercialized as a fixed frequency oscillator, the manufacturer has to consider a balance with establishment as business. The predetermined customer is a so-called major customer, a customer treated as an important customer by a seller, or the like. The major customer is, for example, a customer, sales of the manufacturer to whom involved in a purchase record occupies a certain proportion or more with respect to entire sales. In the following explanation, customers other than the predetermined customer explained above among customers are referred to as “general customers”. The general customers sometimes consider use of the programmable oscillator 300 that can set a desired frequency as an oscillator that outputs a clock signal having a desired frequency. When delivery in a short delivery time is required, the predetermined customer sometimes considers the use of the programmable oscillator 300.

When the user considers the use of the programmable oscillator 300, the user asks the manufacturer to provide a predetermined number of evaluation samples of the programmable oscillator 300 besides a characteristic writing device 400 explained below. Then, the user uses the provided characteristic writing device 400 to perform work of writing desired setting data in the nonvolatile memory provided in the programmable oscillator 300 and integrates the programmable oscillator 300 for which the work has been performed into equipment of the user and evaluates the programmable oscillator 300. When setting data to be written in the programmable oscillator 300 is determined through the evaluation, the user orders the programmable oscillator 300 having mass-production specifications based on the setting data from the manufacturer. Thereafter, the sales agency obtains the setting data relating to the order, writes the setting data in the programmable oscillator 300 using the characteristic writing device 400 owned by the sales agency, and delivers the programmable oscillator 300 in which the setting data is written to the user. In some case, a part of specifications of the characteristic writing device 400 owned by the sales agency is different from the specifications of the characteristic writing device 400 provided to the user to be able to cope with mass production.

When a person in charge of a sales department of the manufacturer is assigned to the user who placed an order and the sales department functions as a marketing department, the person in charge of the sales department sometimes collects, for the user, information such as a purpose of the order and points regarded as important. In other words, the person in charge grasps needs of the user based on wants relating to the order. The needs include not only apparent needs but also potential needs. Specific examples of the needs are explained below. Then, the person in charge considers a proposal satisfying the grasped needs. Thereafter, an oscillator other than the programmable oscillator 300 relating to the order is sometimes proposed to the user by the person in charge. Accordingly, the user can purchase a product matching the purpose of the order most. Accordingly, a closer relation can be built between the manufacturer and the user.

However, the person in charge of sales is assigned only when the user is the predetermined customer. Since the oscillator is widely used and is used by extremely many users, it is difficult to assign persons in charge of sales of the seller to all the general customers. As explained above, when the user is an expected customer among the general customers, it is difficult to communicate with the sales agency. For that reason, when the user is a general customer, in the order of the programmable oscillator 300 via an ordering system or the like of the related art, the manufacturer only mechanically receives wants of the user and cannot receive a proposal considering needs of the user from the person in charge of sales. In that regard, as explained below, the information providing system 100 in the present embodiment can present information concerning the oscillator that can be a solution satisfying the needs of the user to the user, who is the general customer. Therefore, the information providing system 100 serves as a base that can build a closer relation between the manufacturer and the user.

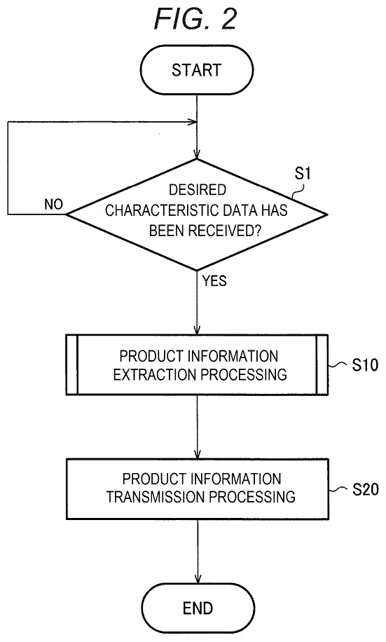

A processing example according to a method in the present embodiment is explained with reference to a flowchart of FIG. 2. The processing unit 120 performs processing of determining whether desired characteristic data has been received (step S1). For example, although not illustrated, the user displays a predetermined screen on the display unit of the user terminal 200. The predetermined screen is, for example, a Web page relating to a product search for an oscillator in a homepage of the manufacturer but may be a screen activated by a writing program explained below. For example, the user can input characteristic data of the oscillator as search parameters to the Web page relating to the product search in order to efficiently search for a desired product. Items that can be the search parameters are, for example, a product category, a frequency, a size, a frequency deviation, and the like but may be other items. In the present embodiment, when desired characteristic data is input using the Web page relating to the product search, it is assumed that the programmable oscillator 300 is selected as the product category. That is, the desired characteristic data relating to step S1 is characteristic data serving as search parameters input by the user for the search on the Web page. The desired characteristic data relating to step S1 may be characteristic data input by the user on a screen activated by the writing program. A specific example of the desired characteristic data is explained below. It is desirable that the desired characteristic data includes a plurality of characteristic data.

When the desired characteristic data has been received (YES in step S1), the processing unit 120 performs product information extraction processing (step S10). On the other hand, when the desired characteristic data has not been received (NO in step S1), the processing unit 120 performs step S1 again. The product information extraction processing (step S10) includes processing of searching for, in a not-illustrated database, product information including the desired characteristic data received in step S1. For example, although details of a flow are omitted, when a frequency is included in the desired characteristic data received in step S1, the processing unit 120 extracts, as compatible product information, the programmable oscillator 300 that is capable of setting the frequency included in the desired characteristic data and coincides with an item other than the frequency included in the desired characteristic data. When a model number of the programmable oscillator 300 is included in the desired characteristic data, the processing unit 120 may include, in step S10, processing of searching for, in the database, information concerning a product coinciding with the model number and extracting the found information concerning the product as compatible product information.

A plurality of pieces of compatible product information may be present. However, when a predetermined number or more of pieces of compatible product information are extracted in step S10, for example, the processing unit 120 may perform processing of transmitting a predetermined command to the user terminal 200 without performing step S20 explained below. The predetermined command is, for example, a command for causing the display unit of the user terminal 200 to display an indication to the effect that the user is caused to reconsider desired characteristic data to be input. This is because, if there is a lot of compatible product information extracted in step S10, needs of the user cannot be accurately grasped.

Step S10 includes processing of extracting substitute product information that is product information of an oscillator to be a substitute proposal target. The oscillator to be the substitute proposal target refers to an oscillator that can satisfy needs of the user who inputs the desired characteristic data and is, specifically, for example, an oscillator compatible with an oscillator including the desired characteristic data, an oscillator in which at least a part of the desired characteristic data is common, an oscillator in which data relating to an additional function is added to the desired characteristic data, or the like. Details of the oscillator to be the substitute proposal target are explained below. A plurality of pieces of substitute product information may be present.

After performing the product information extraction processing (step S10), the processing unit 120 performs product information transmission processing (step S20) and ends the flow. In the product information transmission processing (step S20), the processing unit 120 transmits the product information extracted by the product information extraction processing (step S10) to the user terminal 200 via the transmission unit 130. The product information extracted by the product information extraction processing (step S10) is the compatible product information explained above and substitute product information. In other words, the transmission unit 130 transmits the compatible product information and the substitute product information to the user terminal 200. The substitute product information may be classified into a plurality of kinds. In the present embodiment, for example, as explained below, the substitute product information is classified into two pieces of first substitute product information and second substitute product information. However, the substitute product information may be classified into three or more kinds.

As explained above, the information providing system 100 in the present embodiment includes the reception unit 110, the processing unit 120, and the transmission unit 130. The reception unit 110 receives desired characteristic data of the programmable oscillator 300 input in the user terminal 200. The processing unit 120 extracts compatible product information that is product information of the programmable oscillator 300 compatible with the desired characteristic data and substitute product information that is product information of an oscillator to be a substitute proposal target. The transmission unit 130 transmits the compatible product information and the substitute product information to the user terminal 200.

As explained above, the information providing system 100 in the present embodiment can receive the desired characteristic data from the user by including the reception unit 110. The information providing system 100 in the present embodiment can extract the compatible product information and the substitute product information based on the received desired characteristic data by further including the processing unit 120. Since the information providing system 100 in the present embodiment further includes the transmission unit 130 to thereby transmit the extracted compatible product information and the extracted substitute product information to the user terminal 200, the compatible product information and the substitute product information can be provided to the user.

For example, it is assumed that the reception unit 110 has received “frequency deviation=±50 ppm” as the desired characteristic data. In this case, information “frequency deviation=±50 ppm” is equivalent to the wants explained above. That is, any oscillator will do if “frequency deviation=50 ppm”. As explained below, it is unclear whether this is for the purpose for performing communication by Bluetooth (registered trademark).

For example, when the user is a predetermined customer, a person in charge of sales is assigned to the user. Then, it is assumed that, by communicating with the user, the person in charge of sales has acquired, from the user, information indicating that “wants an oscillator for performing communication by Bluetooth”. In this case, the information indicating that “want an oscillator for performing communication by Bluetooth” is equivalent to the apparent needs. However, with this information alone, it is unclear for what kind of a purpose the communication by Bluetooth is used. For example, the oscillator may be used for a keyboard attached to a computer or may be used for a business intercommunication system but it is uncertain what the oscillator is used for.

Therefore, it is assumed that, by further communicating with the user, the person in charge of sales has further acquired, from the user, information indicating that “want to perform wireless communication adapted to predetermined antenna power”. In this case, “want to perform wireless communication adapted to predetermined antenna power” is equivalent to the potential needs. Accordingly, since it is unnecessary for the person in charge of sales to persist in Bluetooth if the wireless communication is adapted to the predetermined antenna power, the person in charge of sales can find the programmable oscillator 300 adapted to, for example, STD-T67 and can propose the programmable oscillator 300 to the user. Accordingly, for example, when the user wants to develop a transceiver for a business intercommunication system using the programmable oscillator 300, wireless communication adapted to transmission for a longer distance can be implemented. Therefore, the proposal from the person in charge of sales can be a more optimal solution. Accordingly, a closer relation can be built between the manufacturer and the user.

However, when a general customer, to whom a person in charge of sales is not assigned, orders the programmable oscillator 300 with a method relating to the ordering system of the related art, the programmable oscillator 300 equivalent to wants is only delivered. Specifically, for example, when the user, who is a general customer, inputs “frequency deviation=±50 ppm” as desired characteristic data, the user is not given an opportunity to consider an oscillator other than the programmable oscillator 300 having “frequency deviation=±50 ppm”. In this regard, by applying the method in the present embodiment, not only the compatible product information but also the substitute product information can be provided to the user. Accordingly, it is possible to give the user an opportunity to consider whether the substitute product information is more suitable for needs of the user. Accordingly, the user can select an optimum oscillator satisfying the needs. Since it is a burden on the user to propose a change of an oscillator incorporated in equipment under mass production, it is beneficial for the user to be able to select an optimum oscillator at a stage of development. Accordingly, a closer relation can be built between the user, who is the general customer, and the manufacturer. Accordingly, for example, since the user, who is the general customer, can easily adopt the programmable oscillator 300 of the manufacturer, it is possible to increase the possibility that the manufacturer can acquire a new business chance. The method relating to the information providing system 100 in the present embodiment achieves the effects particularly when the user is the general customer. However, the information providing system 100 in the present embodiment may be used when the user is the predetermined customer.

The method in the present embodiment may be implemented by the oscillator providing system 10. That is, the oscillator providing system 10 in the present embodiment includes the information providing system 100 and the user terminal 200 explained above. Thus, the same effects as explained above can be obtained.

The method in the present embodiment may be implemented by a processing method. That is, the processing method in the present embodiment includes processing of receiving desired characteristic data of the programmable oscillator 300 input in the user terminal 200 (step S1). The processing method in the present embodiment further includes processing of extracting compatible product information that is product information of the programmable oscillator 300 compatible with the desired characteristic data and substitute product information that is product information of an oscillator to be a substitute proposal target (step S10). The processing method in the present embodiment further includes processing of transmitting the compatible product information and the substitute product information to the user terminal 200 (step S20). Thus, the same effects as explained above can be obtained.

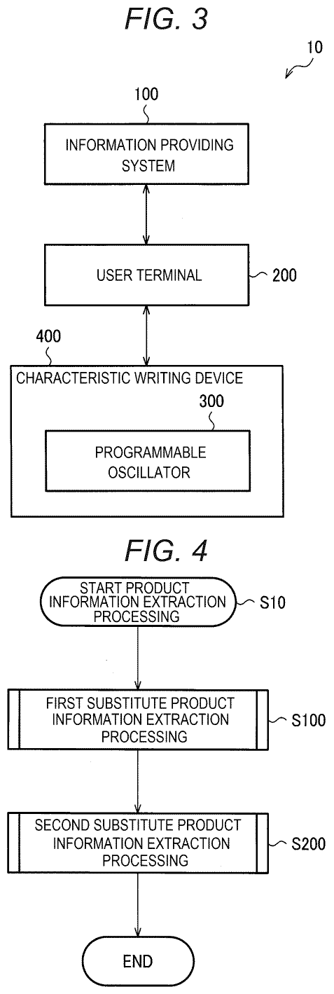

The method in the present embodiment is not limited to the above. Various modified implementations such as adding other features are possible. For example, the oscillator providing system 10 in the present embodiment can also be more specifically configured as in a configuration example illustrated in FIG. 3. In the oscillator providing system 10 illustrated in FIG. 3, the information providing system 100 and the user terminal 200 are connected as in FIG. 1 and the user terminal 200 is further connected to the characteristic writing device 400 by a predetermined communication scheme. The predetermined communication scheme is, for example, a wired connection scheme such as USB. The user terminal 200 connected to the characteristics writing device 400 is mainly a personal computer.

The characteristic writing device 400 includes, on a circuit board, an interface for connection to the user terminal 200, a socket in which a package of the programmable oscillator 300 is fitted, and the like. That is, the characteristic writing device 400 includes an interface circuit connectable to the programmable oscillator 300. The interface circuit is a circuit that implements an interface such as an inter-integrated circuit (I2C) or a serial peripheral interface (SPI) and performs interface processing with the characteristic writing device 400 and the like.

The user starts, for example, a writing program in the user terminal 200 and writes programming information based on the desired characteristic data in the programmable oscillator 300 using a setting screen relating to the writing program. The customer only has to install the writing program in the user terminal 200 using, for example, a CD-ROM attached to the characteristic writing device 400. Alternatively, the customer may download a program relating to the writing program from a Web page designated by the manufacturer. When the user terminal 200 and the characteristic writing device 400 are connected via a USB cable or the like attached to the characteristic writing device 400, the writing program may be automatically installed in the user terminal 200.

The writing program includes a program for automatically calculating the setting value of the register explained above based on a frequency of a reference clock of the programmable oscillator 300 and a desired frequency that the user desires to set. For that reason, the user only has to input the desired frequency as a specific number on a setting screen for the writing program, for example, as explained below with reference to FIG. 7. Accordingly, the setting value of the register to be set is automatically determined.

For example, at timing when the user inputs a predetermined number of setting items on the setting screen, the processing unit of the user terminal 200 may perform processing of transmitting the input setting items to the information providing system 100. The processing may be set as step S1 in FIG. 2. The predetermined number only has to be determined as appropriate considering search efficiency in the product information extraction processing (step S10). Alternatively, at timing when the user performs writing in the programmable oscillator 300, the processing unit of the user terminal 200 may perform processing of transmitting setting data relating to the writing to the information providing system 100 as the desired characteristic data. The processing may be set as step S1 in FIG. 2.

In the configuration example illustrated in FIG. 3, the writing program installed in the user terminal 200 is premised to operate when the user terminal 200 is communicably connected to the information providing system 100. For that reason, it is assumed that, when the user uses the characteristic writing device 400, an agreement to the effect that step S1 is executed when the user terminal 200 and the information providing system 100 are connected is made between the manufacturer and the user. It is assumed that a promise to the effect that the characteristic data relating to step S1 is managed as confidential information is made between the manufacturer and the user.

As explained above, in the information providing system 100 in the present embodiment, the user terminal 200 is communicably connected to the characteristic writing device 400 that sets characteristic data in the programmable oscillator 300. The desired characteristic data is the characteristic data set in the programmable oscillator 300 by the characteristic writing device 400. Thus, the user can learn the substitute product information while performing evaluation by writing.

The method in the present embodiment may be implemented by a processing method. That is, in the processing method in the present embodiment, the user terminal 200 is communicably connected to the characteristic writing device 400 that sets characteristic data in the programmable oscillator 300. The desired characteristic data is the characteristic data set in the programmable oscillator 300 by the characteristic writing device 400. Thus, the same effects as explained above can be obtained.

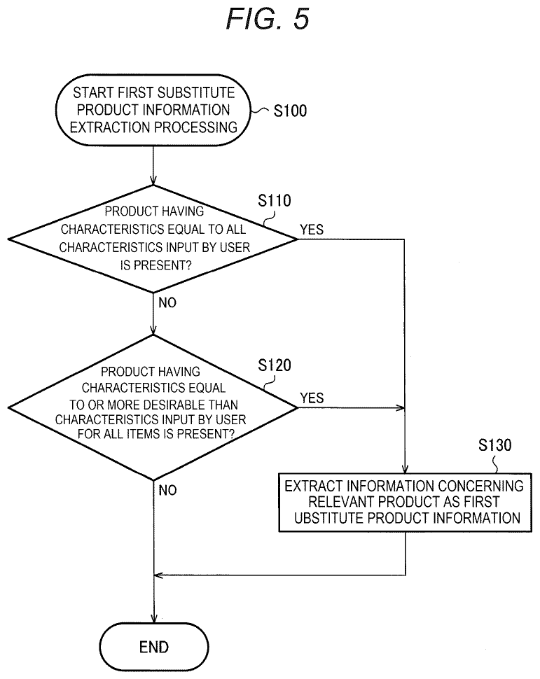

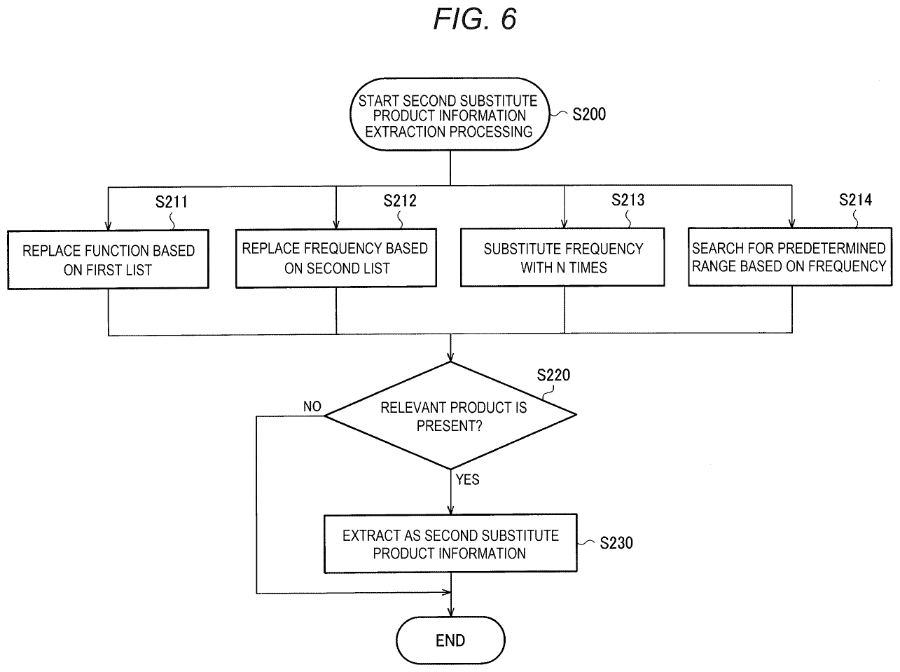

The product information extraction processing (step S10) is explained more in detail with reference to the flowchart of FIG. 4. The processing unit 120 performs compatible product information extraction processing (not illustrated) of extracting compatible product information with a search by an AND condition of characteristic data and thereafter performs first substitute product information extraction processing (step S100). Details of the first substitute product information extraction processing (step S100) are explained below with reference to FIG. 5. After performing the first substitute product information extraction processing (step $100), the processing unit 120 performs second substitute product information extraction processing (step S200) and ends a flow. Details of the second substitute product information extraction processing (step S200) are explained below with reference to FIG. 6.

The first substitute product information extraction processing (step is explained more in detail with reference to a flowchart of FIG. 5. The processing unit 120 determines whether a product having characteristics equal to all characteristics input by the user is present (step S110). More specifically, the processing unit 120 performs, on a not-illustrated database, for each item, processing of extracting a product coinciding with respective data included in the desired characteristic data received in step S1 in FIG. 2. The processing unit 120 performs processing of listing products coinciding with the desired characteristic data for all characteristic items. When information concerning a model number is further acquired in step S1, the processing unit 120 further performs processing of excluding a product relating to the model number from the listed products. Then, the processing unit 120 determines YES in step S110 when there is one or more products to be listed and determines NO in step S110 when there is no product to be listed.

A specific example of being determined YES in step S110 is that, when the desired characteristic data relating to step S1 includes an output frequency, a fixed frequency oscillator that outputs the same output frequency is extracted. In the following explanation, the output frequency included in the desired characteristic data is referred to as desired output frequency. In other words, when the desired output frequency input by the user in the user terminal 200 coincides with the standard frequency explained above, it is determined YES in step S110. Accordingly, information concerning the fixed frequency oscillator is provided as first substitute product information by processing explained below. As explained above, in the information providing system 100 in the present embodiment, the desired characteristic data includes the desired output frequency. The processing unit 120 extracts product information of a fixed frequency oscillator, an output frequency of which coincides with the desired output frequency, as substitute product information. Thus, the user can grasp product information of the fixed frequency oscillator coinciding with the desired output frequency. For example, it is also possible that the user is considering the programmable oscillator 300 in a state in which the user forgets the presence of the fixed frequency oscillator that outputs the desired output frequency. In that regard, by applying the method in the present embodiment, the user can recognize the presence of the fixed frequency oscillator that outputs the desired output frequency. Accordingly, when the user adopts the fixed frequency oscillator, it is possible to improve the performance of equipment incorporating the fixed frequency oscillator and reduce cost of the equipment. However, step S110 does not prevent extraction of another programmable oscillator 300 coinciding with the desired output frequency. The programmable oscillator 300 may be extracted in other processing.

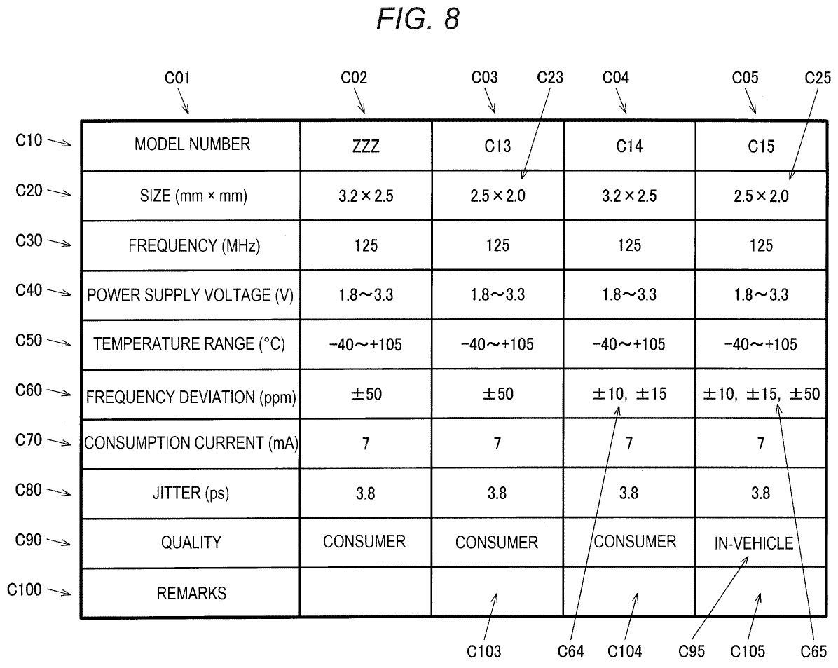

When the desired characteristic data relating to step S1 includes the desired output frequency and when a fixed frequency oscillator that outputs the same output frequency as the desired output frequency is extracted in step S110, information concerning the fixed frequency oscillator may be more preferentially displayed on the user terminal 200 than other substitute product information extracted in step S120 or the like explained below. For example, in FIG. 8 referred to below, by showing the information concerning the fixed frequency oscillator in a column immediately adjacent to compatible product information shown in a column of C02, preferential display can be implemented. As explained above, since it is highly likely that the user is about to order the programmable oscillator 300 considering that there is no fixed frequency oscillator that outputs the desired output frequency, it is beneficial for the user that the presence of the fixed frequency oscillator that outputs the desired output frequency is preferentially indicated to the user.

More specifically, in the product information transmission processing (step S20) in FIG. 2, the transmission unit 130 preferentially transmits the information concerning the fixed frequency oscillator to the user terminal 200. Accordingly, the processing unit of the user terminal 200 can display the information concerning the fixed frequency oscillator to be closer to the compatible product information through predetermined information reception processing, image formation processing, and the like. As explained above, in the information providing system 100 in the present embodiment, the transmission unit 130 preferentially transmits, as the substitute product information, the product information of the oscillator having the standard frequency registered in the database. Thus, the user can preferentially learn the information concerning the oscillator having the standard frequency.

When determining NO in step S110, the processing unit 120 performs processing of determining whether a product having characteristics equal to or more desirable than the characteristics input by the user for all the items is present (step S120). In other words, step S120 is processing of extracting, from a not-illustrated database, a product having upward compatibility with the product relating to the characteristic data received in step S1.

Specific examples of the information relating to the items input by the user include information concerning a size, information concerning an output frequency, information concerning a power supply voltage, information concerning a use temperature range, information concerning a frequency deviation, information concerning a consumption current, information concerning a jitter, and information concerning quality. However, the information may be information relating to other items. As illustrated in FIG. 3, when the user terminal 200 and the characteristic writing device 400 are connected and desired characteristic data is input on the screen for the writing program, the desired characteristic data includes information concerning a model number.

More specifically, the information concerning the size refers to information relating to external dimensions of the package of the programmable oscillator 300. In the information relating to the external dimensions, information concerning the dimension in the thickness direction of the package may be omitted. In step S120, for example, the processing unit 120 performs processing of searching for, in the database, a product including information concerning a size equal to the size in the characteristic data received in step S1 and further performs processing of searching for, in the database, a product including information concerning a size smaller than the size in the characteristic data received in step S1. In other words, it can be considered that the product including the information concerning the size smaller than the size desired by the user has upward compatibility with a product desired by the user. This is because a reduction in the size of the package contributes to an increase in the degree of freedom of design of equipment or the like relating to user development. In the present embodiment, a product, sizes of which in the vertical and horizontal directions in a plan view are small, is exemplified as a product having a small size. However, a product, sizes in the vertical and horizonal directions of which are the same and thickness of which is small, may be set as the product having the small size or a product, all of sizes in the plan view and thickness of which are small, may be set as the product having the small size.

More specifically, the information concerning the output frequency refers to information concerning an output frequency of the programmable oscillator 300 after the writing is performed. In step S120, for example, the processing unit 120 performs processing of searching for, in the database, a product including information concerning a nominal frequency equal to the desired output frequency received in step S1. It is considered that an oscillator including information concerning a nominal frequency different from the desired output frequency received in step S1 does not theoretically have compatibility with the oscillator desired by the user. For that reason, in step S120, the processing unit 120 extracts, as the first substitute product information, product information of an oscillator with which at least information concerning a nominal frequency among the desired characteristic data in step S1 coincides. As explained above, in the information providing system 100 in the present embodiment, the processing unit 120 extracts, as substitute product information, product information of an oscillator with which a part of a plurality of characteristics indicated by the desired characteristic data of the programmable oscillator 300 coincides. Thus, the user can recognize information concerning other products that are likely to satisfy needs.

More specifically, the information concerning the power supply voltage is information concerning an allowable range of a voltage supplied from a power supply to the oscillator. In step S120, for example, the processing unit 120 performs processing of searching for, in the database, a product including information concerning an allowable range of a voltage equal to the power supply voltage in the characteristic data received in step S1 and further performs processing of extracting, from the database, a product having a wider allowable range of a voltage than the power supply voltage in the characteristic data received in step S1. The product having a wider allowable range width of a voltage includes the entire allowable range width of the voltage received in step S1. For example, when the information concerning the power supply voltage received in step S1 is “2.5 V to 3.3 V”, the processing unit 120 extracts products, information concerning a power supply voltage of which is “1.8 V to 3.3 V”, “1.8 V to 3.5 V”, and “2.5 V to 4.0 V”, in step S120 but does not extract a product, information concerning a power supply voltage of which is “2.7 V to 4.0 V”, in step S120. That is, a product having a wider allowable range width of a voltage than power supply voltage desired by the user has upward compatibility with the product desired by the user. This is because the wide allowable range width of the voltage contributes to an increase in a degree of freedom in designing equipment and the like relating to the development of the user. As explained above, the oscillator having the wider allowable range width of the voltage than the power supply voltage in the characteristic data received in step S1 can be considered an oscillator having characteristics higher than the characteristics of the programmable oscillator 300 desired by the user. That is, in the information providing system 100 in the present embodiment, the processing unit 120 extracts, as substitute product information, product information of an oscillator in which at least one characteristic among a plurality of characteristics indicated by the desired characteristic data of the programmable oscillator 300 is higher than a characteristic of the programmable oscillator 300. Thus, the user can recognize the presence of an oscillator having higher characteristics. Note that, for example, in some case, the information concerning the power supply voltage is described as “3.3 V” a range is not clearly written in specifications or the like. This means that display of a predetermined allowable deviation (for example, ±5%) is omitted.

More specifically, the information concerning the temperature range is information concerning an allowable temperature range in an environment in which the oscillator is used. In step S120, for example, the processing unit 120 performs processing of searching for, in the database, a product including information concerning a temperature range equal to the temperature range in the characteristic data received in step S1 and further performs processing of extracting, from the database, a product having a wider allowable temperature range width than the temperature range in the characteristic data received in step S1. The product having the wider allowable temperature range width includes the entire temperature range width received in step S1. For example, when the information concerning the temperature range received in step S1 is “−30° C. to 80° C.”, the processing unit 120 extracts products, information concerning a power supply voltage of which is “−30° C. to 120° C.”, “−40° C. to 80° C.”, and “−40° C. to 120° C.”, in step S120 but does not extract a product, information concerning a power supply voltage of which is “−40° C. to 70° C.”, in step S120. That is, a product having a wider allowable temperature range width than a temperature range desired by the user is considered to have upward compatibility with the product desired by the user. This is because the wide allowable temperature range width in which the oscillator can be used contributes to an increase in a degree of freedom of design of equipment and the like relating to the development of the user.

More specifically, the information concerning the frequency deviation refers to information concerning a ratio of the magnitude of deviation of an output frequency caused by changes in operation conditions such as a temperature change with respect to a reference output frequency. In step S120, for example, the processing unit 120 performs processing of searching for, in the database, a product including information concerning frequency deviation equal to the frequency deviation in the characteristic data received in step S1 and further performs processing of searching for, in the database, a product including information concerning frequency deviation smaller than the frequency deviation in the characteristic data received in step S1. In other words, it can be considered that a product including information concerning frequency deviation smaller than frequency deviation desired by the user has upward compatibility with the product desired by the user. This is because a decrease in deviation of an output frequency of the oscillator cannot be assumed to reduce a degree of freedom of design of equipment and the like developed by the user.

By reducing the frequency deviation, the performance of the equipment developed by the user sometimes can be improved. For example, the user considers to minimize the number of stages of FIFO (First In First Out) of communication equipment. This is because, since the number of stages of the FIFO is proportional to the area of a memory, minimizing the number of stages of the FIFO contributes to a cost reduction. For example, one of factors for determining the number of stages of the FIFO is the frequency of a clock signal supplied to the FIFO. Specifically, the number of stages of the FIFO is considered based on a lower limit value obtained by subtracting the magnitude of deviation from a nominal frequency of the clock signal. For that reason, as the frequency deviation is smaller, the lower limit value is larger. Therefore, since data input to the FIFO of the previous stage is quickly transferred to the FIFO of the subsequent stage, the number of stages of the FIFO can be reduced.

The information concerning the consumption current is information concerning an electric current flowing to the oscillator when the oscillator is caused to operate. In step S120, for example, the processing unit 120 performs processing of searching for, in the database, a product including information concerning the same consumption current as the consumption current in the characteristic data received in step S1 and further performs processing of searching for, in the database, a product including information concerning a consumption current smaller than the consumption current in the characteristic data received in step S1. In other words, it can be considered that a product including information concerning current consumption smaller than the current consumption desired by the user has upward compatibility with the product desired by the user. This is because it cannot be assumed that reducing the current consumption of the oscillator reduces a degree of freedom in designing equipment and the like developed by the user.

The information concerning the jitter is information concerning fluctuation of rising of a clock signal from a not-illustrated oscillation circuit provided in the oscillator. In step S120, for example, the processing unit 120 performs processing of searching for, in the database, a product including information concerning a jitter equal to the jitter in the characteristic data received in step S1 and further performs processing of searching for, in the database, a product including information concerning a jitter smaller than the jitter in the characteristic data received in step S1. In other words, it can be considered that a product including information concerning a jitter smaller than the magnitude of a jitter desired by the user has upward compatibility with the product desired by the user. This is because it cannot be assumed that a degree of freedom in designing equipment and the like developed by the user is reduced when the jitter is further reduced.

The information concerning the quality refers to information concerning a quality standard supported by the oscillator. For example, in the case of an oscillator for consumer use, information indicating that the oscillator is an oscillator manufactured in a factory that has acquired authentication of ISO-9001 is equivalent to the information concerning the quality. For example, in the case of an oscillator for in-vehicle use, information indicating that the oscillator is an oscillator adapted to, for example, AEC-Q 100, AEC-Q 200, or the like is equivalent to the information concerning the quality. For example, a tab for selecting an adapted standard is displayed on a product search web page or the like. Then, the user selects “AEC-Q 100” or the like using the tab. Accordingly, the desired characteristic data relating to step S1 includes the information concerning the quality.

When the information concerning the quality is not included in the desired characteristic data relating to step S1, for example, in step S120, the processing unit 120 performs processing of searching for the information concerning the quality in the database based on data obtained by adding a keyword concerning a quality standard for in-vehicle use such as “AEC-Q 100” to the characteristic data received in step S1. In other words, when a user desires an oscillator for consumer use, it can be considered that an oscillator for in-vehicle use has upward compatibility with the oscillator for consumer use. This is because, as long as the oscillator for in-vehicle use is an oscillator in which characteristic data other than use is the same, it cannot be assumed that replacing the oscillator for consumer use with the oscillator for in-vehicle use reduces a degree of freedom in designing equipment and the like developed by a user.

The second substitute product information extraction processing (step S200) is explained in detail with reference to a flowchart of FIG. 6. The processing unit 120 performs processing of replacing a function based on a first list (step S211), processing of replacing a frequency of a peripheral function based on a second list (step S212), processing of replacing an output frequency with an integer multiple of an input frequency (step S213), and processing of searching for a predetermined range based on the input frequency (step S214).

In step S211, specifically, for example, the processing unit 120 performs, for a product extracted from the characteristic data received in step S1, the processing of replacing a function based on the first list.

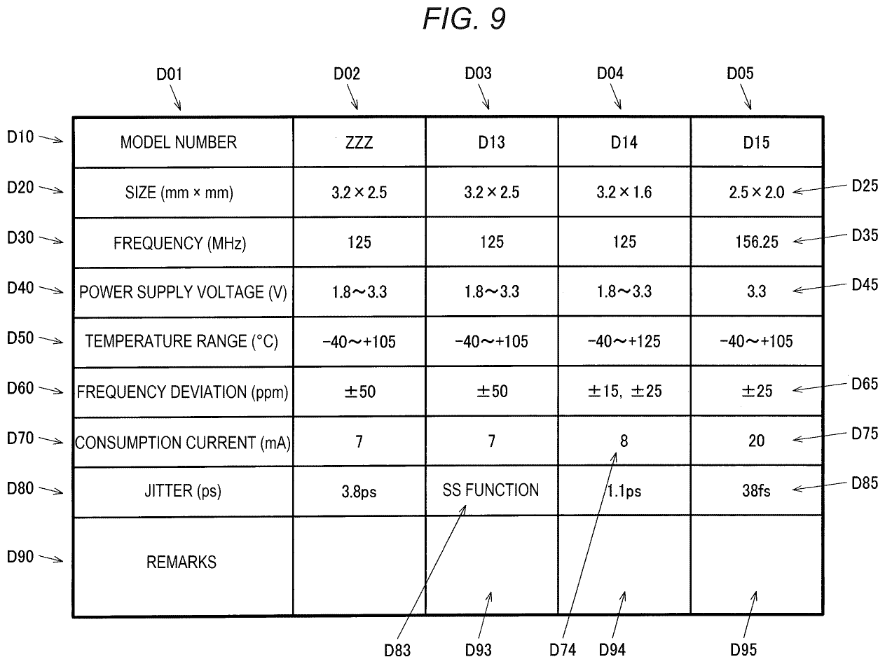

Although step S211 in FIG. 9 exemplifies only “replacement”, “addition” or “deletion” may be performed. The first list includes a table in which products having common predetermined characteristic data are correlated. For example, a product having a spread spectrum function and a product not having the spread spectrum function are correlated. The spread spectrum function is a publicly-known method of reducing EMI (Electro Magnetic Interference) noise by periodically changing a frequency of an output clock signal in a predetermined frequency band centering on a reference frequency that is the frequency of the clock signal. In the following explanation, the spread spectrum function is simply described or illustrated as “SS function”.

For example, it is assumed that the information concerning the programmable oscillator 300 including the characteristic data received in step S1 includes only product information not having the spread spectrum function. In this case, in step S211, the processing unit 120 performs processing of replacing the information concerning the programmable oscillator 300 including the characteristic data received in Step S1 with information having the spread spectrum function. Thereafter, in step S220, the processing unit 120 performs processing of searching for, in the not-illustrated database, a product including the information substituted in step S211 and, when the relevant product is present in the database, determines YES in step S220 and performs processing of extracting the product as the second substitute product information (step S230). As explained above, steps S211, S220, and S230 function as processing of extracting, as the second substitute product information, an oscillator having the spread spectrum function as an additional characteristic other than the characteristics indicated by the desired characteristic data received in step S1. That is, in the information providing system 100 in the present embodiment, the processing unit 120 extracts, as the substitute product information, product information of an oscillator having an additional characteristic other than the plurality of characteristics indicated by the desired characteristic data of the programmable oscillator 300. Thus, the user can recognize the presence of the oscillator having the additional characteristic.

The first list is not limited to the above. For example, the first list may be a list in which information concerning a product having a multi-output function and information concerning a product not having the multi-output function are correlated. Various modified implementations are possible.

In step S212, specifically, for example, the processing unit 120 performs, for the product extracted from the characteristic data received in step S1, processing of replacing a frequency based on the second list. The second list includes a table in which products that output a predetermined frequency are correlated based on business negotiation records and the like in the past. For example, it is assumed that it is known from sales record data of the manufacturer that the programmable oscillator 300 ordered for a predetermined use is often ordered for a first oscillator that outputs a first frequency and a second oscillator that outputs a second frequency. It is assumed that both of the first frequency and the second frequency are not the standard frequency. In this case, when the characteristic data received in step S1 includes information concerning the first frequency, the characteristic data is likely to be data input by the user with the intention of considering the first oscillator. Therefore, the processing unit 120 replaces the information concerning the output frequency among the characteristic data received in step S212 and thereafter extracts information concerning the second oscillator as information concerning the second substitute product in subsequent steps S220 and S230. Accordingly, the user can learn the presence of the second oscillator.

In step S213, specifically, for example, the processing unit 120 performs processing of multiplying the desired output frequency included in the characteristic data received in step S1 by N (N is a natural number equal to or larger than 2). An upper limit of N is determined as appropriate. Thereafter, the processing unit 120 determines whether product information including characteristic data after the processing in step S220 is included in the database. In step S230, the processing unit 120 extracts, as information concerning the second substitute product, the product information included in the database in step S220. For example, by increasing the output frequency of the programmable oscillator 300 to N times, a multiplier of the PLL circuit can be reduced. Accordingly, the jitter sometimes can be reduced.

In step S214, specifically, for example, the processing unit 120 searches for, in the database, product information including a nominal frequency in a predetermined range based on the desired output frequency included in the characteristic data received in step S1. Specifically, the processing unit 120 searches for, in the database, product information in which, when a predetermined ratio is represented as d %, an oscillation frequency of an output frequency that is ±d % with respect to the desired output frequency is set as a nominal frequency. Here, ±d % does not include 0. This is because the nominal frequency is the same as the desired output frequency when ±d % includes 0 and step S110 in FIG. 7 is sufficient.

Thereafter, in step S220, the processing unit 120 determines whether the product information in which the oscillation frequency of the output frequency that is ±d % with respect to the desired output frequency is set as the nominal frequency is included in the database. In step S230, the processing unit 120 extracts the product information included in the database in step S220 as the second substitute product information.

The nominal frequency included in the second substitute product information extracted in steps S214, S220, and S230 is not the same as the desired output frequency included in the desired characteristic data received in step S1. Therefore, the nominal frequency theoretically does not have compatibility. However, as a result of incorporating the second substitute product into equipment and the like under development by the user and actually evaluating the equipment and the like, if the equipment and the like operate without any problem, needs of the user are satisfied. Since the second substitute product is a fixed frequency oscillator, the second substitute product is more advantageous in terms of cost and the like compared with the programmable oscillator 300 as explained above and is likely to be more beneficial for the user. In performing the evaluation for minimizing the number of stages of the FIFO explained above, evaluation by an oscillator having a slightly increased frequency is performed for a desired frequency. When there is a fixed frequency oscillator corresponding to the implementation of the evaluation, since the cost and the like relating to the evaluation can be reduced, this is beneficial for the user.

As explained above, in the information providing system 100 in the present embodiment, the desired characteristic data includes the desired output frequency. The processing unit 120 extracts, as the substitute product information, an oscillator having, when a predetermined ratio is represented as d %, an oscillation frequency of an output frequency that is different from the desired output frequency and is ±d % with respect to the desired output frequency. Thus, the user can recognize information concerning an oscillator that outputs a frequency close to the desired frequency.

The processing of extracting the second substitute product information is not limited to steps S211 to S214. For example, although not illustrated, for example, when information concerning a model number is included in the desired characteristic data received in step S1, the processing unit 120 may perform, as step S230, processing of replacing the model number with a predetermined model number based on a third list and extract the replaced model number as the second substitute product information. The third list includes, for example, a table in which an oscillator having a record of being adopted in equipment conforming to the first standard and an oscillator developed on the assumption that the oscillator is used in equipment conforming to the second standard which is a standard of the next generation with respect to the first standard are associated with each other. For example, in some case, since an oscillator conforming to the second standard is developed with the emphasis on making characteristic data of one item desirable, characteristic data of another item is not desirable compared with characteristic data of another item of an oscillator conforming to the first standard. In this case, since information concerning the oscillator conforming to the second standard is determined as NO in step S120, the information is not displayed on the user terminal 200 as the first substitute product information. However, since a use of the oscillator conforming to the second standard is common to a use of the oscillator conforming to the first standard, the information concerning the oscillator conforming to the second standard is highly likely to satisfy needs of the user and has a value of being proposed. Therefore, the information concerning the oscillator conforming to the second standard is extracted as the second substitute product information. For example, the third list may include a table showing a combination of oscillators that have few items common to the desired characteristic data and are considered to have no compatibility at a glance but empirically clearly have results satisfying needs of the user.

Action effects obtained when the method in the present embodiment is applied are explained. For example, as explained above with reference to FIG. 3, by connecting the user terminal 200 and the characteristic writing device 400, for example, a screen illustrated in A0 in FIG. 7 is displayed on the display unit of the user terminal 200. In a screen example illustrated in A0, a setting screen illustrated in B0, a sub-screen illustrated in C0, and a sub-screen illustrated in D0 are respectively displayed.

On the setting screen illustrated in B0, for example, a tab for selecting a model number illustrated in B1, a tab for selecting a size illustrated in B2, a box for inputting a nominal frequency illustrated in B3, a tab for setting a power supply voltage illustrated in B4, a tab for selecting a temperature range illustrated in B5, and a tab for selecting a frequency deviation illustrated in B6 are displayed. Items displayed on the setting screen are not limited to the items illustrated in B1 to B6. Other items may be displayed. The other items are, for example, an item for selecting an output enable function or a standby function. The output enable function refers to a function of setting an output terminal to high impedance while keeping the oscillation circuit and the PLL circuit operating. The standby function refers to a function of stopping the oscillation circuit and the PLL circuit and setting the output terminal to a low level. On the setting screen illustrated in B0, only the tabs and the box are illustrated as user interfaces to be selected. However, not only this, but publicly-known user interfaces such as a radio button may be adopted as appropriate. On the setting screen illustrated in B0, when one setting item is determined, another setting item may be displayed and determined in association with the one setting item. For example, when the user selects a model number in which there is only one kind of frequency deviation, the frequency deviation may be determined and displayed in association with the model number.

For example, when the user sets various setting items on the setting screen illustrated in B0, the compatible product information and the first substitute product information are displayed on the screen illustrated in C0. Details of the screen illustrated in C0 are explained below with reference to FIG. 8. For example, when the user sets various setting items on the setting screen illustrated in B0, the compatible product information and the second substitute product information are displayed on the screen illustrated in D0. Details of the screen illustrated in D0 are explained below with reference to FIG. 9.

FIG. 8 is a diagram illustrating a screen example illustrated in C0 in FIG. 7 more in detail. Information concerning a model number is displayed in a row illustrated in C10, information concerning a size is displayed in a row illustrated in C20, information concerning a frequency is displayed in a row illustrated in C30, information concerning a power supply voltage is displayed in a row illustrated in C40, and information concerning a temperature range is displayed in a row illustrated in C50. Information concerning a frequency deviation is displayed in a row illustrated in C60, information concerning current consumption is displayed in a row illustrated in C70, information concerning a jitter is displayed in a row illustrated in C80, information concerning a use is displayed in a row illustrated in C90, and remarks information is displayed in a row illustrated in C100. Various items relating to product information are displayed in a column illustrated in C01. The information concerning the product extracted in step S100 is displayed for each item in columns illustrated in C02, C03, C04, and C05. In FIG. 8, the product illustrated in C02 is the compatible product information and the products illustrated in C03, C04, and C05 are the first substitute product information. Although three pieces of the first substitute product information are illustrated in FIG. 8, the number of pieces of the first substitute product information is not limited to three. The same applies to the second substitute product information illustrated in FIG. 9. For convenience of explanation, respective sections formed by the rows illustrated in C10, C20, C30, C40, C50, C60, C70, C80, C90, and C100 and the columns illustrated in C01, C02, C03, C04, and C05 in FIG. 8 are referred to as “cells”. The same applies to FIG. 9.

For example, in FIG. 8, when the compatible product information (a model number “ZZZ”) illustrated in C02 and the first substitute product information (a model number “C13”) illustrated in C03 are compared, information concerning a size (2.5 mm×2.0 mm) illustrated in a cell of C23 is different from information concerning a size (3.2 mm×2.5 mm) relating to the compatible product information, and the other kinds of information are common. As explained above, since a smaller size is more suitable, the first substitute product information illustrated in C03 is extracted in step S120.

Although not illustrated in FIG. 8, in remarks information illustrated in a cell of C103, information indicating that a size is smaller may be displayed as information indicating an advantageous point of the first substitute product information illustrated in C03. For example, in the information providing system 100, a not-illustrated memory stores information concerning a predetermined fixed phrase and a table in which content of the processing performed in step S120 and the information concerning the fixed phrase are correlated. Then, in step S20, the processing unit 120 only has to transmit, via the transmission unit 130, the information concerning the fixed phrase correlated with the processing of step S120 because step S120 has been performed to the user terminal 200 together with the substitute product information. Display of information can be implemented by the same method for cells illustrated in C104 and C105 in FIG. 8 and cells illustrated in D93, D94, and D95 in FIG. 9 explained below.

When the compatible product information (the model number “ZZZ”) illustrated in C02 and the first substitute product information (a model number “C14”) illustrated in C04 are compared, information (±10 ppm and ±15 ppm) of a frequency deviation illustrated in a cell of C64 is different from information (±50 ppm) concerning a frequency deviation relating to the compatible product information, and the other kinds of information are common. As explained above, narrower width of a frequency deviation is more suitable. Therefore, the first substitute product information illustrated in C04 is extracted in step S120.

When the compatible product information (the model number “ZZZ”) illustrated in C02 and the first substitute product information (model number “C15”) illustrated in C05 are compared, for example, information concerning quality (in-vehicle) illustrated in a cell of C95 is different from information concerning quality (consumer) relating to the compatible product information. As explained above, since the in-vehicle quality is more suitable than the consumer use quality, the first substitute product information illustrated in C04 is extracted in step S120. The first substitute product information illustrated in C05 is the same as the case of the first substitute product information illustrated in C03, although information concerning a size illustrated in a cell of C25 is different from the information concerning the size relating to the compatible product information. Information concerning a frequency deviation illustrated in a cell of C65 is different from the information concerning the frequency deviation relating to the compatible product information but is considered to be the same as the case of the first substitute product information illustrated in C04.

FIG. 9 is an example illustrating the screen example illustrated in D0 in FIG. 7 more in detail. Information concerning a model number is displayed in a row illustrated in D10, information concerning a size is displayed in a row illustrated in D20, information concerning a frequency is displayed in a row illustrated in D30, information concerning a power supply voltage is displayed in a row illustrated in D40, and information concerning a temperature range is displayed in a row illustrated in D50. Information concerning a frequency deviation is displayed in a row illustrated in D60, information concerning current consumption is displayed in a row illustrated in D70, information concerning a jitter is displayed in a row illustrated in D80, and remarks information is displayed in a row illustrated in C90. Although not illustrated in FIG. 9, for example, like the information illustrated in the column C90 in FIG. 8, information concerning quality may be able to be further displayed. Various items relating to product information are displayed in a column illustrated in D01, the compatible product information extracted in step S100 is displayed in a column illustrated in D02, and the second substitute product information extracted in step S200 is displayed for each item in columns illustrated in D03, D04, and D05.

For example, in FIG. 9, when the compatible product information (the model number “ZZZ”) illustrated in D02 and the second substitute product information (a model number “D13”) illustrated in the column of D03 are compared, the second substitute product illustrated in the column of DO3 is different in that information indicating that a spread spectrum function is included is illustrated in a cell of D83, and the other kinds of information are common. That is, since the second substitute product illustrated in the column of D03 indicates that an additional function called spread spectrum function is present for the compatible product information illustrated in D02, the second substitute product illustrated in the column of D03 is extracted as the second substitute product in steps S211, S220, and S230 in FIG. 6.

When the compatible product information (the model number “ZZZ”) illustrated in D02 and the second substitute product information (a model number “D14”) illustrated in the column of D04 are compared, information concerning consumption current illustrated in a cell of D74 is larger than a value of consumption current of the compatible product information illustrated in D02. In this regard, the second substitute product is not desirable as a substitute product. However, the second substitute product information (the model number “D14”) illustrated in the column of D04 is information relating to a product for the next generation with respect to the compatible product information (the model number “ZZZ”) illustrated in D02. The second substitute product information is highly likely to satisfy needs of the user. Therefore, a product having the model number “ZZZ” and a product having the model number “D14” are correlated by the third list explained above. The processing unit 120 extracts information concerning the product having the model number “D14” as the second product information with the second product information extraction processing (step S200).

In the second substitute product information (a model number “D15”) illustrated in the column of D05, when being compared with the compatible product information (the model number “ZZZ”) illustrated in D02, characteristic data illustrated in cells of D25, D35, D45, D65, D75, and D85 is different from corresponding characteristic data in the compatible product information. However, for example, from business negotiation records and the like in the past, it is likely that needs of the user are common even if values indicated in the characteristic data are different. It is sometimes known that customer needs for the product having the model number “ZZZ” and customer needs for a product having the model number “D15” are common. For example, in some case, respective characteristic data of an oscillator, output specifications of which are a CMOS output, and respective characteristic data of an oscillator, output specifications of which are an LVDS output, are different from each other, but needs of the oscillators are common.

In this case, the product having the model number “ZZZ” and the product having the model number “D15” are correlated by the third list explained above. The processing unit 120 extracts information concerning the product having the model number “D15” as the second product information with the second product information extraction processing (step S200).

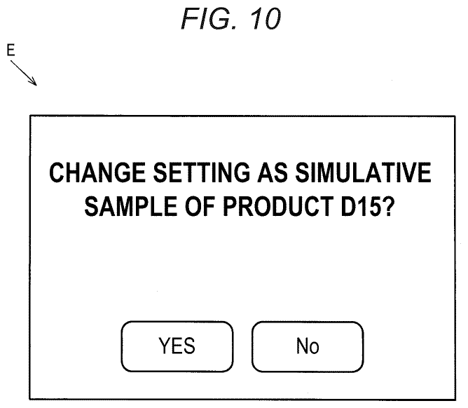

For example, the information providing system 100 may not only display the substitute product information illustrated in FIGS. 7 to 9 but also urge the user to manufacture the programmable oscillator 300 by way of trial based on the displayed substitute product information. For example, it is assumed that the user has viewed the display illustrated in A0 in FIG. 7 on the display unit of the user terminal 200. It is assumed that the user is interested in the product (the model number D15) illustrated in D05 in FIG. 9 and has selected a part relating to the product. At this time, for example, the processing unit 120 displays a screen example illustrated in E in FIG. 10.

As explained above, the processing method in the present embodiment further includes processing of urging the user to write the characteristic data based on the substitute product information in the programmable oscillator 300. Thus, it is possible to urge the user to manufacture the programmable oscillator 300 based on the displayed substitute product information. For example, the second substitute product information displayed on the sub-screen illustrated in D0 in FIG. 7 includes the information concerning the fixed frequency oscillator. However, since the fixed frequency oscillator is an oscillator for mass production and, in some case, there is stock in a factory but there is no stock in a sales agency, a certain period is required until the user acquires an oscillator relating to the substitute product information. For example, the same frequency as the frequency of the product (the model number D15) illustrated in D05 in FIG. 9 is written in the programmable oscillator 300 to urge the user to manufacture a simulative evaluation sample. Accordingly, the user can obtain new knowledge based on an evaluation result of the manufactured programmable oscillator 300. It is possible to reduce a period required for the user to evaluate the oscillator relating to the second substitute product information.

For example, the processing unit 120 may perform processing of replacing the information illustrated in the column illustrated in D03 with the information of the setting item illustrated in the screen example illustrated in B0 in FIG. 7 when the user selects the information illustrated in the column illustrated in D03. For example, when the user is urged to manufacture the second substitute product information (the model number “D15”) illustrated in the column of D05 by way of trial, since a frequency to be set is different from the compatible product information (the model number “ZZZ”) illustrated in D02, the user needs to input the frequency box illustrated in B3 of FIG. 7 again. Further, it is likely that the user errs in the input. In that regard, since the setting of the frequency is automatically changed by applying the method in the present embodiment, the user can reliably manufacture the evaluation sample that the user is urged to manufacture by way of trial.

The above explains that, when the characteristic writing device 400 is connected to the user terminal 200, the writing program starts and the screen examples illustrated in FIGS. 7 to 10 are displayed. However, for example, the user may be able to start the writing program in the user terminal 200 without connecting the characteristic writing device 400 to the user terminal 200. That is, the user may use the writing program in the user terminal 200 to simulate the extracted substitute product information while changing the characteristic data set in the programmable oscillator 300. As explained above, in the information providing system 100 in the present embodiment, the processing unit 120 presents, to the user of the user terminal 200, the setting of the characteristics of the programmable oscillator 300 compatible with the characteristics of the oscillator to be the substitute proposal target. Thus, the user can grasp the setting information relating to the characteristics of the oscillator to be the substitute proposal target.

As explained above, an information providing system in the present embodiment includes a reception unit, a processing unit, and a transmission unit. The reception unit receives desired characteristic data of a programmable oscillator input in a user terminal. The processing unit extracts compatible product information that is product information of the programmable oscillator compatible with the desired characteristic data and substitute product information that is product information of an oscillator to be a substitute proposal target. The transmission unit transmits the compatible product information and the substitute product information to the user terminal.

Thus, the information providing system in the present embodiment can provide the compatible product information and the substitute product information to a user. Accordingly, it is possible to give the user an opportunity to consider whether the substitute product information is more suitable for needs of the user. Accordingly, the user can select an optimum oscillator satisfying the needs.

The processing unit may extract, as the substitute product information, product information of an oscillator with which a part of a plurality of characteristics indicated by the desired characteristic data of the programmable oscillator coincides.

Thus, the user can recognize information concerning other products that are likely to satisfy needs.

The processing unit may extract, as the substitute product information, product information of an oscillator having additional characteristics other than a plurality of characteristics indicated by the desired characteristic data of the programmable oscillator.

Thus, the user can recognize the presence of the oscillator having the additional characteristic.

The processing unit may extract, as the substitute product information, product information of an oscillator in which at least one of a plurality of characteristics indicated by the desired characteristic data of the programmable oscillator is higher than the characteristic of the programmable oscillator.

Thus, the user can recognize the presence of an oscillator having higher characteristics.

The desired characteristic data may include a desired output frequency, and the processing unit may extract, as the substitute product information, product information of a fixed frequency oscillator, an output frequency of which coincides with the desired output frequency.

Thus, the user can grasp product information of the fixed frequency oscillator coinciding with the desired output frequency.

The desired characteristic data may include a desired output frequency, and the processing unit may extract, as the substitute product information, an oscillator having, when the predetermined ratio is represented as d %, an oscillation frequency of an output frequency that is different from the desired output frequency and is ±d % with respect to the desired output frequency.

Thus, the user can recognize information concerning an oscillator that outputs a frequency close to the desired frequency.

The transmission unit may preferentially transmit, as the substitute product information, product information of an oscillator having a standard frequency registered in a database.

Thus, the user can preferentially learn the information concerning the oscillator having the standard frequency.

The processing unit may present, to a user of the user terminal, setting of characteristics of the programmable oscillator compatible with characteristics of the oscillator to be the substitute proposal target.

Thus, the user can grasp the setting information relating to the characteristics of the oscillator to be the substitute proposal target.

In the information providing system, the user terminal may be communicably connected to a characteristic writing device that sets characteristic data in the programmable oscillator, and the desired characteristic data may be the characteristic data set in the programmable oscillator by the characteristic writing device.

Thus, the user can learn the substitute product information while performing evaluation by writing.

An oscillator providing system in the present embodiment includes the information providing system explained above and a user terminal.

A processing method in the present embodiment includes: processing of receiving desired characteristic data of a programmable oscillator input in a user terminal; and processing of extracting compatible product information that is product information of the programmable oscillator compatible with the desired characteristic data and substitute product information that is product information of an oscillator to be a substitute proposal target. The processing method in the present embodiment further includes processing of transmitting the compatible product information and the substitute product information to the user terminal.

In the processing method explained above, the user terminal may be communicably connected to a characteristic writing device that sets characteristic data in the programmable oscillator, and the desired characteristic data may be the characteristic data set in the programmable oscillator by the characteristic writing device.

The processing method in the present embodiment may further include processing of urging the user to write the characteristic data based on the substitute product information in the programmable oscillator.

Thus, it is possible to urge the user to manufacture the programmable oscillator based on the displayed substitute product information.

Although the present embodiment is explained in detail above, those skilled in the art could easily understand that many modifications are possible without substantially departing from the novel matters and the effects of the present disclosure. Therefore, all such modifications are included in the scope of the present disclosure. For example, a term described at least once together with a different term having a broader meaning or the same meaning in the specification or the drawings can be replaced with the different term at any place in the specification or the drawings. All combinations of the present embodiment and the modifications are also included in the scope of the present disclosure. The configurations and the operations of the information providing system, the oscillator providing system, the processing method, and the like are not limited to those explained in the present embodiment, and various modified implementations are possible.

What is claimed is:

1. An information providing system comprising:
a reception unit configured to receive desired characteristic data of a programmable oscillator input in a user terminal;
a processing unit configured to extract compatible product information that is product information of the programmable oscillator compatible with the desired characteristic data and substitute product information that is product information of an oscillator to be a substitute proposal target; and
a transmission configured to transmit the compatible product information and the substitute product information to the user terminal.

2. The information providing system according to claim 1, wherein the processing unit extracts, as the substitute product information, product information of an oscillator with which a part of a plurality of characteristics indicated by the desired characteristic data of the programmable oscillator coincides.

3. The information providing system according to claim 1, wherein the processing unit extracts, as the substitute product information, product information of an oscillator having additional characteristics other than a plurality of characteristics indicated by the desired characteristic data of the programmable oscillator.

4. The information providing system according to claim 1, wherein the processing unit extracts, as the substitute product information, product information of an oscillator in which at least one of a plurality of characteristics indicated by the desired characteristic data of the programmable oscillator is higher than the characteristic of the programmable oscillator.

5. The information providing system according to claim 1, wherein
the desired characteristic data includes a desired output frequency, and
the processing unit extracts, as the substitute product information, product information of a fixed frequency oscillator, an output frequency of which coincides with the desired output frequency.

6. The information providing system according to claim 1, wherein
the desired characteristic data includes a desired output frequency, and
the processing unit extracts, as the substitute product information, an oscillator having, when the predetermined ratio is represented as d %, an oscillation frequency of an output frequency that is different from the desired output frequency and is ±d % with respect to the desired output frequency.

7. The information providing system according to claim 1, wherein the transmission unit preferentially transmits, as the substitute product information, product information of an oscillator having a standard frequency registered in a database.

8. The information providing system according to claim 1, wherein the processing unit presents, to a user of the user terminal, setting of characteristics of the programmable oscillator compatible with characteristics of the oscillator to be the substitute proposal target.

9. The information providing system according to claim 1, wherein
the user terminal is communicably connected to a characteristic writing device that sets characteristic data in the programmable oscillator, and
the desired characteristic data is the characteristic data set in the programmable oscillator by the characteristic writing device.

10. An oscillator providing system comprising:
the information providing system according to claim 1; and
the user terminal.

11. A processing method comprising:
processing of receiving desired characteristic data of a programmable oscillator input in a user terminal;
processing of extracting compatible product information that is product information of the programmable oscillator compatible with the desired characteristic data and substitute product information that is product information of an oscillator to be a substitute proposal target; and
processing of transmitting the compatible product information and the substitute product information to the user terminal.

12. The processing method according to claim 11, wherein
the user terminal is communicably connected to a characteristic writing device that sets characteristic data in the programmable oscillator, and
the desired characteristic data is the characteristic data set in the programmable oscillator by the characteristic writing device.

13. The processing method according to claim 12, further comprising processing of urging the user to write the characteristic data based on the substitute product information in the programmable oscillator.
